(19) United States
(12) Patent Application Publication
(10) Pub. No.: US 2009/0063590 A1
(43) Pub. Date: Mar. 5, 2009

(54) Operating System Support of Graceful Degradation for Web Applications

(75) Inventors: Gideon A. Yuval, Mercer Island, WA (US); Xuedong David Huang, Bellevue, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 11/848,027

(22) Filed: Aug. 30, 2007

(51) Int. Cl. G06F 12/00

(52) U.S. Cl. 707/205; 707/E17.008

(57) ABSTRACT

Systems and methods for storing a copy of a web page accessed by the user while the user is online and displaying the web page upon a user request while working offline are described. The web pages may be accessed by the user while working online and automatically copied and stored in the memory. While operating in an offline mode, the user can access any of the web pages that were viewed. When the user is working in offline mode inputs a web page query into the browser, the browser checks if the web page requested is present in the memory. If the webpage exists in the memory, the browser fetches and displays the web page on the browser window. In case the requested web page is not available in the local memory, a message can be displayed on the browser indicating that the requested web page is not available.

### BACKGROUND

Typically, web browsers store accessed web pages in a cache on a local disk or memory. This procedure is inherently performed to increase browsing speed, allowing the browser to retrieve parts of previously accessed web pages directly from the cache itself instead of requesting the web pages from the web server. Such stored web pages are at times known as the browser cache or temporary Internet files. These web pages may be dependent on browser settings. In addition, different web browsers on a user device may store their own web page caches separately. Generally, once the cache memory is full, new web pages cannot be stored in the cache.

Furthermore, web pages stored in the browser's cache memory may not enable a user to view the web pages in cases when the user cannot access the web pages online. For example, if the user is no longer connected to the network or alternatively if the web page is not available due for whatever reason, the user may not be able to access the web page. In many situations, it is desirable to access such web pages and the information they provide, when the user is offline and is not able to access the web site providing content or an “out to lunch” (unavailable) web page.

### SUMMARY

This summary is provided to introduce concepts relating to operating system support for web applications. These concepts are further described below in the detailed description. The presented summary is not intended to identify essential features of the claimed subject matter, nor is it intended for use in determining the scope of the claimed subject matter.

In one implementation, a memory is reserved in a computing device. Web content received from a network is stored in the reserved memory and access is provided to a user to browse the stored web content through a browser.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates exemplary network architecture for implementing an operating system support for web applications in online mode.

FIG. 2 illustrates an exemplary architecture for retrieving a web page while operating in an offline mode.

FIG. 3 illustrates a computing device for implementing an operating system support for web applications.

FIG. 4A illustrates an example web page retrieved from the memory in offline mode.

FIG. 4B illustrates another example web page retrieved from the memory in offline mode.

FIG. 5 illustrates exemplary method(s) for implementing operating system support for web applications in online mode.

FIG. 6 illustrates exemplary method(s) for implementing operating system support for web applications in offline mode.

FIG. 7 illustrates an exemplary computing device.

### DETAILED DESCRIPTION

A description of systems and methods for implementing an operating system support for web applications follows. The following section describe processes that allow a user device to store a copy of each webpage that the user visits while the user is online, and allows the user to view the stored web pages later when the web pages are not available. Web pages contain a number of data and resources such as images, text, raw data and other type of data. All the resources associated with a web page can be stored onto memory of the user device when the user device accesses the web page online. The memory can be external to the user device or an internal part of the user device.

Generally, a problem arises when the network connection fails or the web page becomes inaccessible due to some foreseen or unforeseen reason, and the user cannot view the web page. In such cases, a copy of the web page stored in the local memory can be displayed.

In operation, when the user is online (i.e., connected to a web server), the web pages accessed by the user can be automatically copied and stored in the memory. The memory may be an integral part of the user device or an external memory. In one implementation, the memory can be a first in first out (FIFO) buffer of pre-defined capacity. A FIFO buffer allows users to store data until the buffer reaches its full capacity. Once the buffer is full and new data has to be added, it automatically deletes data that was stored in the buffer initially. Thus the buffer maintains the latest data in memory for future reference, e.g., recent web pages surfed by the user. In one implementation, the users can specify the memory size or capacity of the memory.

The amount of data stored in the buffer depends on the size of the memory. For example, if 1 GB of memory is allocated for storing web data, then approximately a week's data can be stored in the memory. Each webpage that the user accesses when online may be automatically stored into the memory irrespective of its contents, size, etc. The files corresponding to the web page may be stored in formats that are easily accessible by various web browser (e.g., Microsoft® Internet Explorer® browser, Mozilla® Firofox® browser, etc.) on the user device. Examples of file formats include Hypertext Markup Language (HTML) file, an image file, a text file, etc. In certain implementations, a query input by a user while searching online can also be stored along with the web page associated with that query. This improves the efficiency of the application and can prevent errors from occurring.

In an implementation, when the user is disconnected from the network or is offline, the user can access any of the web pages that were viewed recently, provided they are stored in the memory. When the user is working in offline mode inputs a web page query into the browser, the browser checks if the web page requested is present in the memory. If the webpage exists in the memory, the browser fetches and displays the web page on the browser window. Since the web page may be displayed as it appeared the last time when the user accessed the web page, the displayed web page may be a stale version of the web page and not a refreshed version. Therefore, the displayed web page should be marked in an obvious manner (e.g., bordered in “red” or decorated with an icon such as a “skull & crossbones”). In case the requested web page is not available in the local memory, a message can be displayed on the browser indicating that the requested web page is not available. Furthermore, if a local copy of the web page (i.e., web page stored in local memory) is displayed, because a live copy of the web page is not available, and indicator, such as an icon, may be displayed to the user. As further discussed below, such an icon explicitly indicates that the web page is off-line.

### An Exemplary System

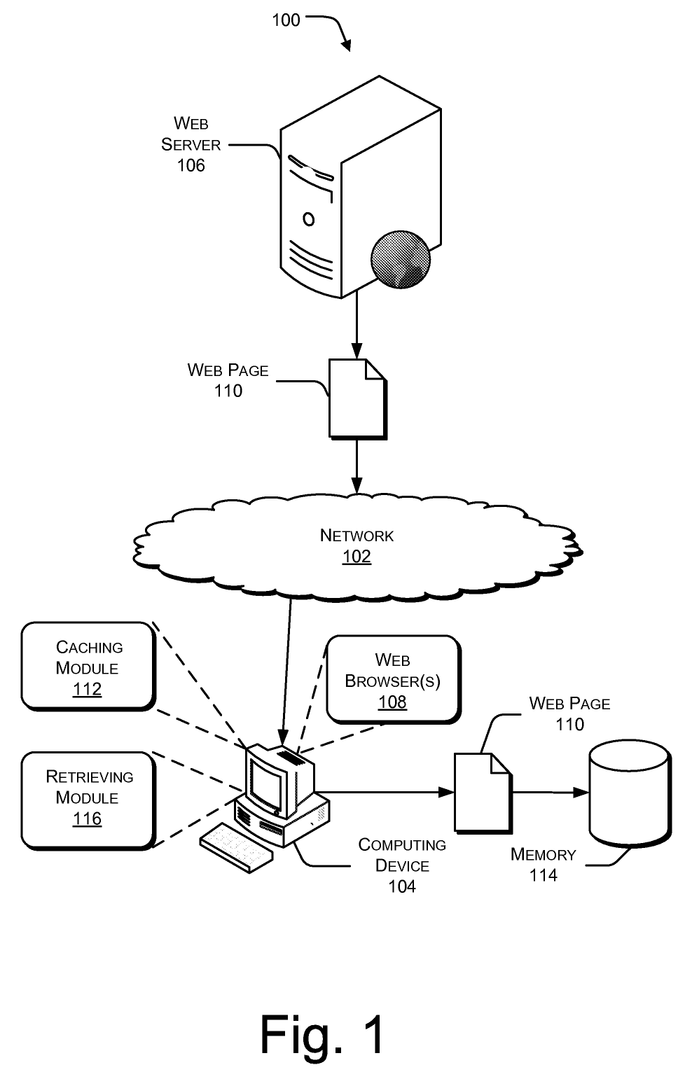

FIG. 1 shows an exemplary system 100 for implementing an operating system support for web applications. To this end, the system 100 includes a network 102 through which one or more computing devices 104 communicate with a web server 106. For example, the system 100 can be the World Wide Web, including numerous personal computers (PCs), web servers, and other computing devices spread throughout the world. Alternatively, in another implementation, the system 100 can include a limited number of PCs communicating with a single server through a local area network (LAN) or wide area network (WAN) or any other networks.

The network 102 can be a local area network (LAN), wide area network, wireless network, optical network, metropolitan area network (MAN), etc. The computing device 104 can be a general-purpose computing device, a laptop, a mobile computing device, etc.

In an implementation, the web server device 106 can be Apache® Hypertext Transfer Protocol (HTTP) web server, Microsoft® web server, Sun® web server, etc. The web server 106 receives requests for web pages from web browser(s) 108 present on the computing device(s) 104. Examples of web brower(s) include Microsoft® Internet Explorer® browser and Mozilla® Firofox® browser. Additionally, the web server 106 serves data content, which usually are web pages such as Hypertext Markup Language (HTML) documents and linked objects (images, etc.) to the computing device(s) 104. In one implementation, the web server can also have additional features such as authentication, which is an optional authorization request before allowing access to some or all kinds of resources. For example, usually e-mail servers require user authorization and authentication before allowing users to access their personal e-mail accounts. The web server 106 can be associated with or include a database. The database may contain web pages, text, images and some other type of data that can be requested from the web server 106.

In the present implementation, the web server 106 can be accessible by computing device(s) 104 through the network 102 using one or more protocols, for example a transmission control protocol running over an internet protocol (TCP/IP). The computing device(s) 104 sends a request for a web page 110 (web page 110 may be also be representative of or include other data and data formats, as discussed above) to the web server 106 when operating in an online mode. The web page 110 can be either a static page or a dynamic page. A static web page can be for example, a web page that comprises the same information in response to all download requests from all users. A dynamic web page can be for example, a web page that provides an interactive experience. Thus, in a dynamic web page, the content (text, images, form fields, etc.) on a web page can change, in response to different contexts or conditions.

The request for the web page 110 may be input as a query by a user through a web browser in the computing device 104. The web server 106 provides the web page 108 associated with the query to the computing device 104. The web page 108 may be displayed through the web browser window to the user. The computing device 104 includes a caching module 112 that can collect and store a copy of the web page 108 in a memory 114. The memory 114 can be an external memory, for example, a flash memory. Alternatively, the memory 114 can be internal and a part of the local memory inherent in the computing device 104. For example, Dynamic Random Access Memory (DRAM), local hard drives and so on.

In an implementation, while accessing a page online, the computing device 104 checks whether the web page 110 requested from the web server 106 already exists in the memory 114. In this case, the caching module 112 checks whether the web page 110 has been updated since the last instance the caching module 112 had stored the web page 110 in the memory 114. If the web page 110 has been refreshed, the caching module 112 can overwrite the previous stale web page 110 with the newer version of the web page 110. Alternatively, the caching module 112 does not store the web page 110 again.

Once the system 100 is in an offline mode i.e. when the network 102 is disconnected, the user can send a query for a web page that was previously accessed through the web browser. The query can be processed by a retrieving module 116 present on the computing device 104. The retrieving module 116 retrieves the requested web page from the memory 114 to display on the web browser(s) 108.

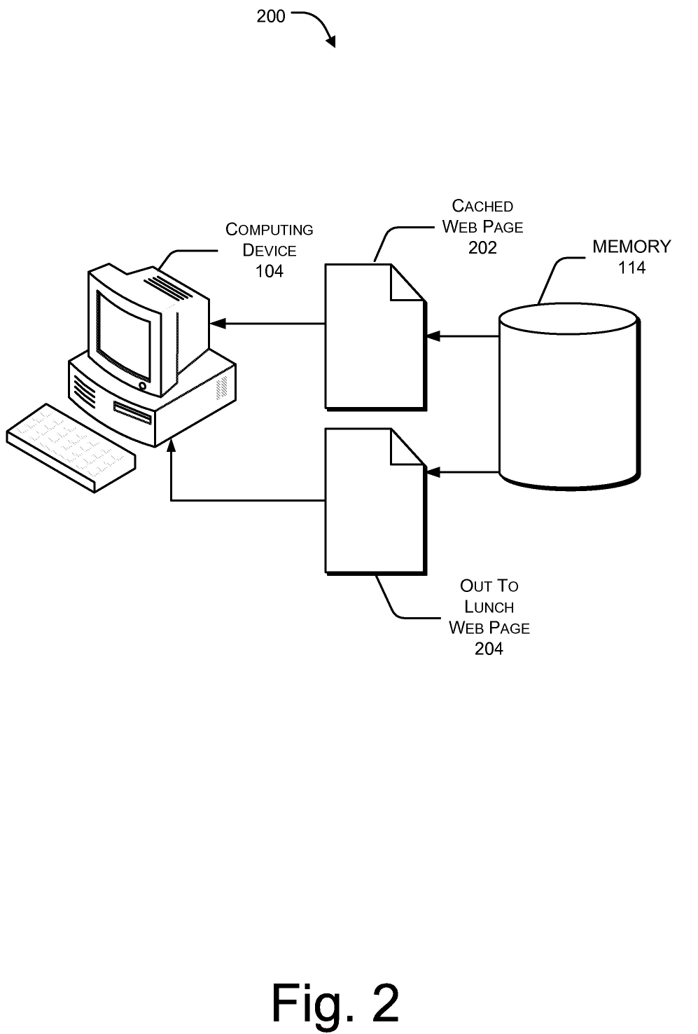

FIG. 2 illustrates an implementation 200 showing the retrieval of a web page while operating in an offline mode. The user inputs a query for a web page 108 through the computing device 104 in a web browser(s) 108 window. The web browser(s) 108 checks whether a network connection exists. If the network connection does not exist, the web browser(s) 108 requests the retrieving module 116 to search the memory 114 for the web page 110.

In an implementation, the retrieving module 116 checks the memory 114 for pre-stored user queries corresponding to the query input by the user. If the queries match, the stored web page 110 or cached web page 202 associated with the query is fetched from the memory 114 and displayed on the web browser(s) 108 window.

In an embodiment, the cached web page 202 displayed on the web browser(s) 108 may be displayed with a warning stating that the web page displayed is a cached web page 202 and not a web page 110 obtained directly from the web server 106. Additionally, the links and buttons present on a particular cached web page 202 that lead the user to a web page that is not stored in the memory may be grayed out. The user will not be allowed to click on these links, as no data corresponding to these links/buttons are stored in the memory 114. Thus, the user becomes aware that the cached web page 202 is stale and has limitations in the data available. In additional an “out to lunch” web page 204 may displayed indicating unavailability.

### Exemplary Computing Device

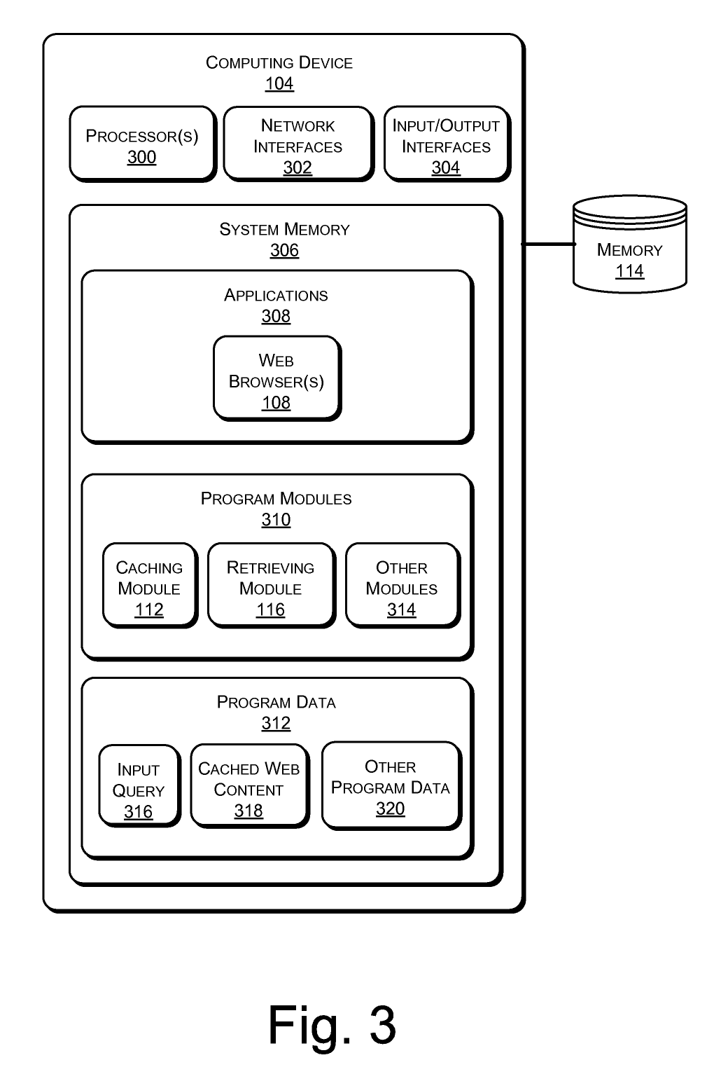

FIG. 3 illustrates a computing device 104 that implements the operating system (OS) support for web applications. The computing device 104 stores accessed web pages on a memory that is not controlled by or associated with the web browser. The computing device 104 can include one or more processors 300, along with network interfaces 302, input/output interfaces 304 and a system memory 306.

Processor(s) 300 can be a single processing unit or a number of units, all of which could include multiple computing units. The processor(s) 300 may be implemented as one or more microprocessors, microcomputers, microcontrollers, digital signal processors, central processing units, state machines, logic circuitries, and/or any devices that manipulate signals based on operational instructions. Among other capabilities, the processor(s) 300 can be configured to fetch and execute computer-readable instructions stored in the system memory 306.

The network interface(s) 302 facilitates communication between the web server 106 and the computing device(s) 104. Furthermore, the network interface(s) 302 may include one or more ports for connecting a number of computing devices 104 to the web server 106. The network interface(s) 302 can facilitate communications within a wide variety of networks and protocol types, including wired networks (e.g. LAN, cable, etc.) and wireless networks (e.g. WLAN, cellular, satellite, etc.). The web server 106 receives an input query from a user or a computing device 104 client via the ports connected through the network interface(s) 302 and the web server device 106 can send back the retrieved relevant document list back to the computing device 104 via the network interface(s) 302.

The input/output interfaces 304 can provide input-output capabilities for the computing device 104. The input/output interfaces 304 can include one or more ports for connecting a number of device controllers as input devices and a display device as one of the output devices, and so on. In one implementation, the computing device 104 receives input data in the form of queries from users through input/output interfaces 304. Input/output interfaces 304 may include, for example, a mouse port, a keyboard port and so on.

System memory 306 includes, for example, volatile memory (e.g. RAM, DRAM) and non-volatile memory (e.g. ROM, EPROM etc). System memory 306 includes applications 308 which include web browser(s) 108.

The system memory 306 further includes program modules 310 and program data 312. The program modules 310 include caching module 112, retrieving module 116 and other modules 314. Program data 312 can include an input query 316, cached web content 318 and other program data 320. Other program data 320 stores various data that may be generated or required during the functioning of the computing device 104.

In operation, the computing device 104 receives an input query 316 for a web page 110. When online (i.e., connected to network 102 and web server 106), the computing device 104 collects the web page 110 from the web server 106 and displays it to the user. The caching module 112 collects all web content associated with the web page 110 and stores a copy of the web content as cached page or cached web content 318 in the memory 114. In an implementation, the caching module 112 stores the input query 316 corresponding to the web page 108 along with the web page 108. The input query 316 and the cached web content 318 may be stored in the memory 114.

The memory 114 can be external memory for example, an external disk drive, an USB drive, etc. Alternately, the memory 114 can be internal memory, for example, it can be volatile memory (e.g., RAM, DRAM) or non-volatile memory (e.g., flash), and include or be part of system memory 306. The size of the memory 114 can be adjusted or adjustable by the user. For example, the user can decide how much space may be allocated for web content. It follows that the larger amount of space allocated to the memory 114 (and larger memory 114), the more history of web content can be stored and accessed.

In an implementation, the memory 114 can be a first in first out (FIFO) buffer for finite space. Once the buffer (i.e., memory) is full, the web pages that were stored first in the buffer are deleted. In this manner, the latest web pages can be automatically be stored into the memory 114 without interrupting the user or asking the user to manually delete data from the memory 114.

In an exemplary implementation, the caching module 112 can store the web content or any data from the transport layer of the OSI or TCP/IP model directly into the memory 114. The OSI reference model or the TCP/IP model is a layered abstract description for communication and computer network. The layers of the TCP/IP model are application layer, transport layer, network layer, data link layer and the physical layer. The web content is stored after the transport layer as the transport layer provides end to end data transfer capabilities independent of the underlying network, along with error control, fragmentation and flow control. The transport layer is a layer of the TCP/IP stack that offers data reliability.

Once the computing device 104 is in an offline mode or when the computing device 104 is disconnected from the network 102, or if the web browser detects that a web page requested by the user is unavailable, a request is sent to the retrieving module 116 to process an input query associated with requested web page. In one implementation, the retrieving module 116 compares the input query from the user with the input query 316 stored in program data 312. If there is a match, the web page (e.g., web page 110) corresponding to the input query 314 is retrieved from the cached web content 318.

Alternately, in another implementation, the retrieving module 116 checks the input query from the user with the web pages stored in the memory 114. If a match is found, the web page (e.g., web page 108) is directly retrieved from the memory 114 by the retrieving module 116.

In an implementation, the retrieving module 116 checks if other web pages linked to the web page requested by the user are also stored in the memory 114. If any links or buttons, present on the requested web page lead to web pages that are not stored in the memory 114, the retrieving module 116 grays out those links and buttons before sending the requested web page 110 to the web browser(s) 108. In case the input query does not match any web pages stored in the memory 114, the retrieving module 116 returns an error message.

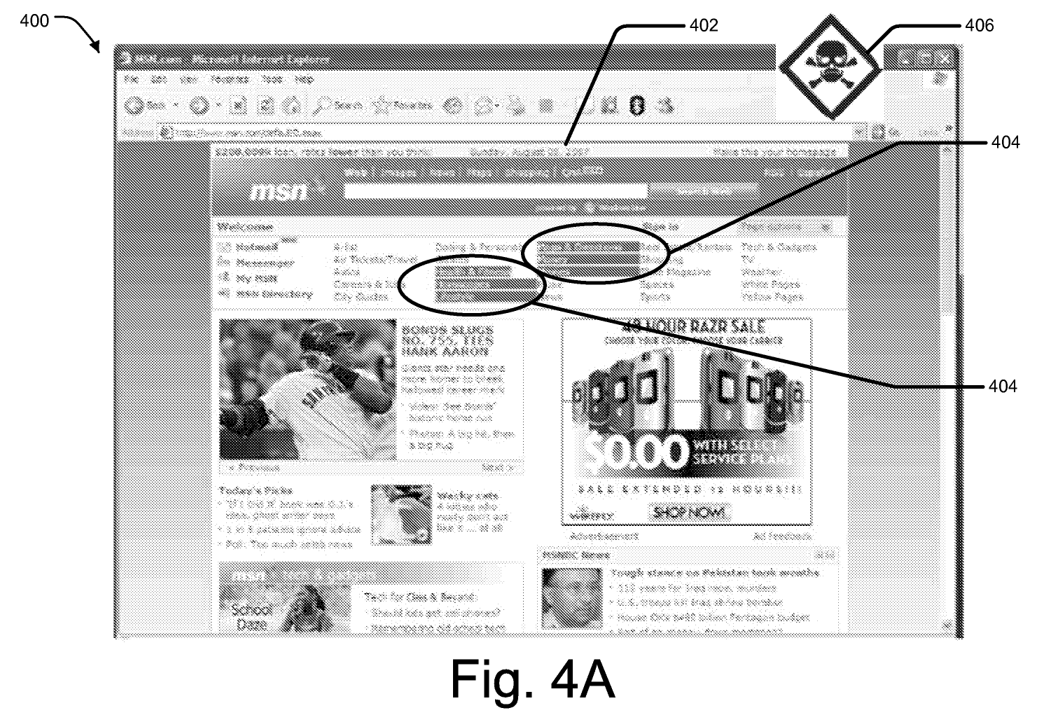

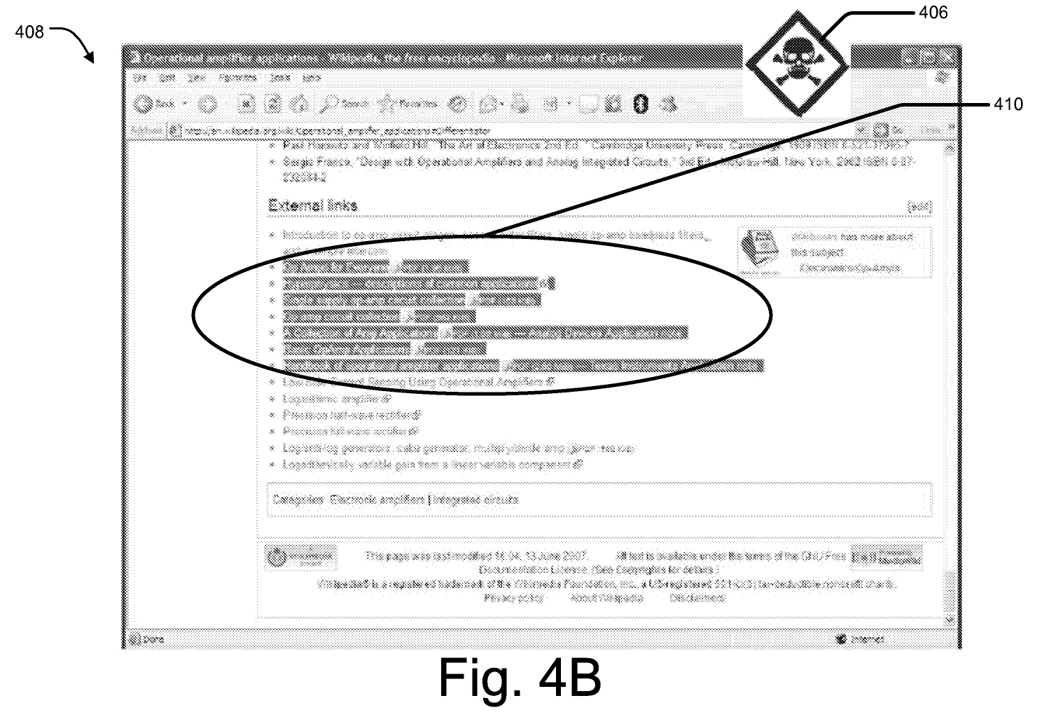

FIG. 4A illustrates an exemplary webpage 400 retrieved from the memory in offline mode. The web page 400 in this example is a home page of the Microsoft® Network (MSN). The web page 400 is a cached webpage retrieved by the retrieving module 116 in the offline mode for a user request. Icon 402 shows the date the cached webpage 400 was last accessed when the user was online. It is noted that this is web page specific and all web pages may not show such information.

In an implementation, the retrieving module 116 can change the background color of the cached web page 400 to inform the user that the web page is a stale web page. In another implementation, the retrieving module 116 can indicate to the user that the web page is stale, by flashing a written statement stating that the web page is from the memory 114.

In an implementation, regions 404 indicate the grayed out buttons of the web page. The grayed out buttons may relate to links that were not previously accessed by the user, and therefore copies of those links may not exist in the memory 114. In such a case, the user can be made aware of the limitations of the web page (i.e., the user can be warned beforehand).

Furthermore, an icon 406 may be provided that explicitly indicates that the web page is off-line. This icon may be used with, or in place, of color indicators.

FIG. 4B illustrates another example webpage 406 retrieved from the memory in offline mode. The web page 406 is also a cached web page, retrieved by the retrieving module 116. This example webpage is a Wikipedia® web page describing operational amplifiers. The portion of the web page 406 illustrated in this example shows the external links available for access. The external links may not be related to the Wikipedia® site, (i.e. they can be independent articles, web pages, and other documents about the same topic). Region 408 shows grayed out external links on this website associated with the web page 406. The caching module 112 may store a copy of the web pages corresponding to the links that are not highlighted, in the memory 114. If the user clicks on any of the links that are not highlighted, the retrieving module 116 can retrieve the stored copy of the web page corresponding to that particular link, from the memory 114 and display it to the user through the web browser. The user may not be allowed to click on any of the grayed buttons.

In one implementation, the hyperlinks associated with the highlighted links may be removed, thereby treating the hyperlinks as plain text. Therefore, even if the user clicks on the highlighted text, no action would be taken.

### Exemplary Methods

Exemplary processes for storing a copy of the web page and subsequently displaying the web page to the user while working offline are described with reference to FIGS. 1-4. These processes may be described in the general context of computer executable instructions. Generally, computer executable instructions can include routines, programs, objects, components, data structures, procedures, modules, functions, and the like that perform particular functions or implement particular abstract data types. The processes may also be practiced in a distributed computing environment where functions are performed by remote processing devices that are linked through a communications network. In a distributed computing environment, computer executable instructions may be located in both local and remote computer storage media, including memory storage devices.

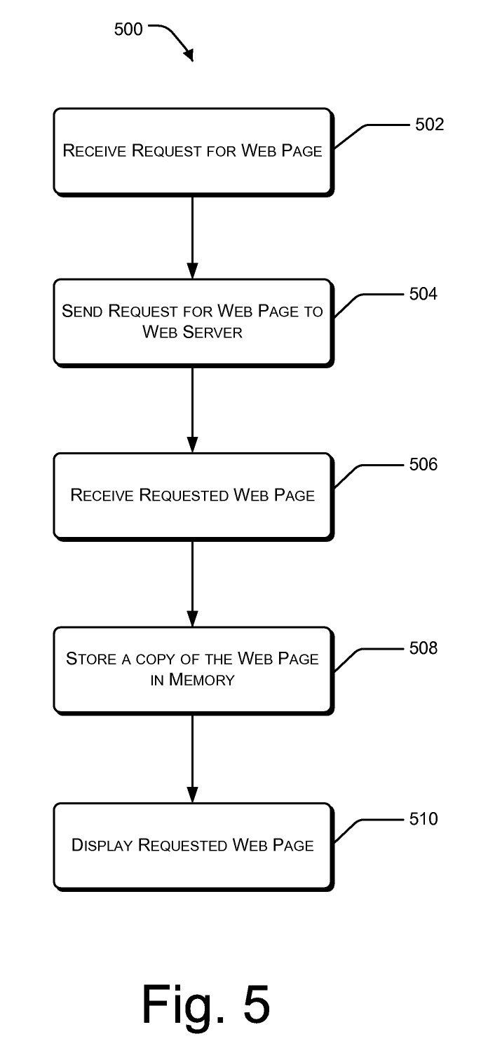

FIG. 5 illustrates an exemplary method 500 for storing a copy of a web page while displaying the web page to the user when the user is online. Process 500 is illustrated as a collection of blocks in a logical flow graph, which represents a sequence of operations that can be implemented in hardware, software, or a combination thereof. In the context of software, the blocks represent computer instructions that, when executed by one or more processors, perform the recited operations.

The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method can be implemented in any suitable hardware, software, firmware, or a combination thereof, without departing from the scope of the invention.

At block 502, the computing device 104 receives a request for a web page from a user. In one implementation, the user types the address of the web page in an address bar of a web browser in the computing device 104. In another implementation, the user can use an internet search engine such as the Google® search engine, the Microsoft® live search engine and so on, to find the desired web page.

At block 504, the web browser sends the request to a web server. For example, the web browser sends the request for the web page required by the user to the web server 106. The web browser can use transfer protocols such as, Hypertext Transfer Protocol (HTTP), file transfer protocol (FTP), and so on, to send information regarding the web page to the web server 106. The request typically includes the address of the web page through which the web page can be found using a Uniform Resource Locator (URL).

At block 506, the web browser receives the requested web page 110. In an implementation, the web server 106 sends the information about the web page 110 to the web browser 108. The information sent by the web server 106 can include the web page and other information such as the format and properties of the web page 110. Further, the web server 106 may request for a login username or password for authentication. In this case, the user may validate the authentication procedure to obtain the requested web page. For example, the IEEE website requires users to authenticate themselves before receiving any information or web content from the web server.

In another implementation, when the user requests for a web page 110 that has recently been accessed by the user, the web browser 108 may check if any web content pertaining to the desired web page 110 is present in the memory 114. If any web content associated with the desired web page exists, the retrieving module 116 retrieves the content from the memory 114, thereby allowing the content to be displayed much faster than receiving the entire content from the web server 106.

At block 508, a copy of the web page 108 displayed is stored in memory 114. For example, the caching module 110 stores a copy of the web page requested by the user in the memory 114. In an implementation, the caching module 110 directly stores the web page in the memory 114, if the memory 114 does not have a previous copy of the web page 108. In another implementation, the caching module 112 overwrites the older version of the web page present in the memory 114 with the newer version of the web page 108.

Furthermore, the caching module 112 checks the capacity of the memory 114 each time data is stored in the memory 114. The caching module 112 may warn the user when the memory 114 reaches its full capacity (i.e., defined or preset size limit). In an implementation, the caching module 112 can delete the oldest web pages stored in the memory 114 if the memory 114 is a first in first out buffer.

At block 510, the web browser renders the web content received from the web server 106 into a format that displays the web content as a web page on the web browser window.

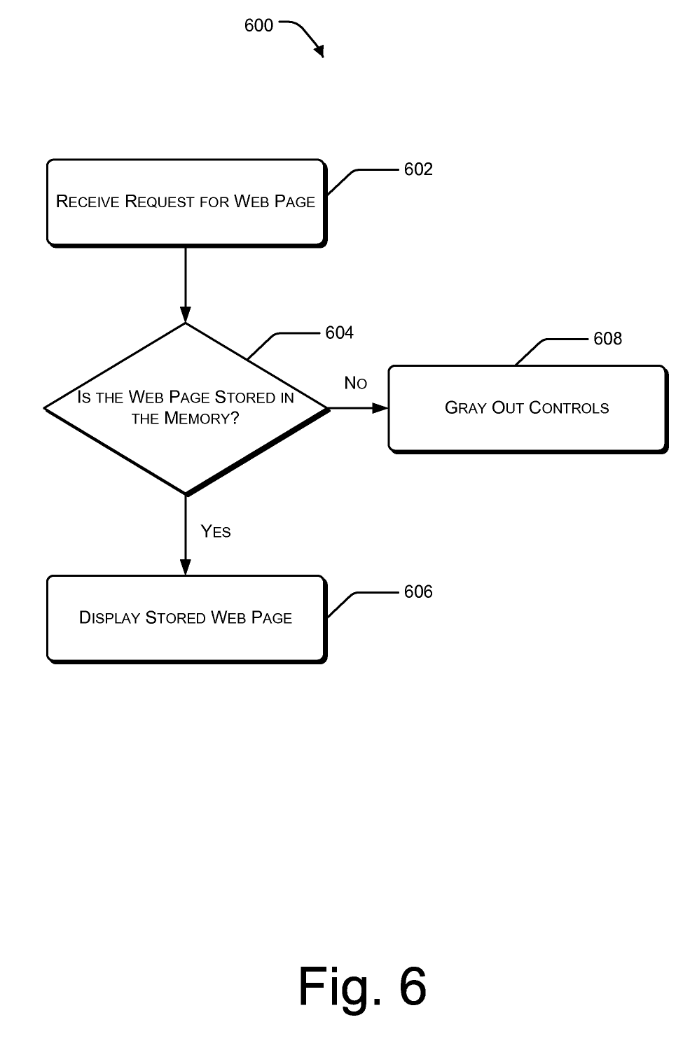

FIG. 6 illustrates an exemplary method 600 for retrieving and displaying stored web pages in the absence of a network connection or unavailability of a web page online. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method can be implemented in any suitable hardware, software, firmware, or a combination thereof, without departing from the scope of the invention.

At block 602, the web browser in the computing device 104 receives a request for a web page from the user. Since the computing device 104 is either not connected to the network 102, or the requested web page is not available at the web server 106, the web browser can not retrieve the web page from the web server 106.

At block 604, a determination is made whether the requested web page is stored in the memory. If the requested web page is found (i.e. the ‘yes’ path from block 604), then the method 600 moves to block 606 and the requested web page is retrieved from the memory 114. Alternatively, if the requested web page is found (i.e. the ‘no’ path from block 604), then the method 600 moves to block 608 and controls to get to the web page may be “grayed out” or appropriately identified.

In one implementation, the retrieving module 114 compares the user query related to the requested web page with queries stored in the memory 114. Once a match is found, the corresponding web page is displayed to the user. While, if it is determined that none of queries stored matches the user query, an error message may be displayed.

In another implementation, the retrieving module 114 determines directly whether the user query matches with a web page stored in the memory 114. Once a match is found, the corresponding web page is displayed to the user. While, if determined that none of queries stored matches the user query, an error message is displayed.

In an implementation, fetching may be performed on past web pages and associated “predicted” possible pages the user may want to visit based on history. These web pages may cached in the memory and updated in the background so that web information can be relatively up to date. Possible new web pages may be predicted based on a web server page's statistics (e.g., how many people visited a specific page would also visit other pages).

### Exemplary Computing Environment

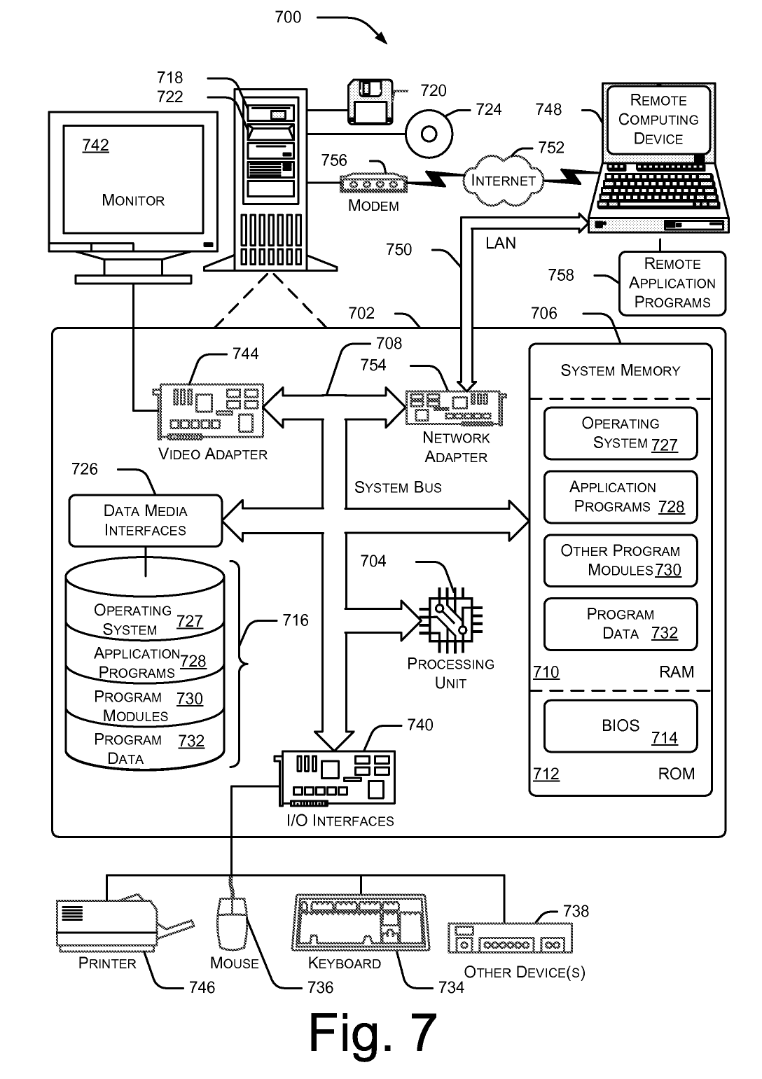

FIG. 7 illustrates an exemplary general computer environment 700, which can be used to implement the techniques described herein, and which may be representative, in whole or in part, of elements described herein. The computer environment 700 is only one example of a computing environment and is not intended to suggest any limitation as to the scope of use or functionality of the computer and network architectures. Neither should the computer environment 700 be interpreted as having any dependency or requirement relating to any one or combination of components illustrated in the example computer environment 700.

Computer environment 700 includes a general-purpose computing-based device in the form of a computer 702. Computer 702 can be, for example, a desktop computer, a handheld computer, a notebook or laptop computer, a server computer, a game console, and so on. The components of computer 702 can include, but are not limited to, one or more processors or processing units 704, a system memory 706, and a system bus 708 that couples various system components including the processor 704 to the system memory 706.

The system bus 708 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 702 typically includes a variety of computer readable media. Such media can be any available media that is accessible by computer 702 and includes both volatile and non-volatile media, removable and non-removable media.

The system memory 706 includes computer readable media in the form of volatile memory, such as random access memory (RAM) 710, and/or non-volatile memory, such as read only memory (ROM) 712. A basic input/output system (BIOS) 714, containing the basic routines that help to transfer information between elements within computer 702, such as during start-up, is stored in ROM 712 is illustrated. RAM 710 typically contains data and/or program modules that are immediately accessible to and/or presently operated on by the processing unit 704.

Computer 702 may also include other removable/non-removable, volatile/non-volatile computer storage media. By way of example, FIG. 7 illustrates a hard disk drive 716 for reading from and writing to a non-removable, non-volatile magnetic media (not shown). furthermore FIG. 7 illustrates a magnetic disk drive 718 for reading from and writing to a removable, non-volatile magnetic disk 720 (e.g., a “floppy disk”), additionally FIG. 7 illustrates an optical disk drive 722 for reading from and/or writing to a removable, non-volatile optical disk 724 such as a CD-ROM, DVD-ROM, or other optical media. The hard disk drive 716, magnetic disk drive 718, and optical disk drive 722 are each connected to the system bus 708 by one or more data media interfaces 726. Alternately, the hard disk drive 716, magnetic disk drive 718, and optical disk drive 722 can be connected to the system bus 708 by one or more interfaces (not shown).

The disk drives and their associated computer-readable media provide non-volatile storage of computer readable instructions, data structures, program modules, and other data for computer 702. Although the example illustrates a hard disk 716, a removable magnetic disk 720, and a removable optical disk 724, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 716, magnetic disk 720, optical disk 724, ROM 712, and/or RAM 710, including by way of example, an operating system 726, one or more application programs 728, other program modules 730, and program data 732. Each of such operating system 726, one or more application programs 728, other program modules 730, and program data 732 (or some combination thereof) may implement all or part of the resident components that support the distributed file system.

A user can enter commands and information into computer 702 via input devices such as a keyboard 734 and a pointing device 736 (e.g., a “mouse”). Other input devices 738 (not shown specifically) may include a microphone, joystick, game pad, satellite dish, serial port, scanner, and/or the like. These and other input devices are connected to the processing unit 1504 via input/output interfaces 740 that are coupled to the system bus 708, but may be connected by other interface and bus structures, such as a parallel port, game port, or a universal serial bus (USB).

A monitor 742 or other type of display device can also be connected to the system bus 708 via an interface, such as a video adapter 744. In addition to the monitor 742, other output peripheral devices can include components such as speakers (not shown) and a printer 746, which can be connected to computer 702 via the input/output interfaces 740.

Computer 702 can operate in a networked environment using logical connections to one or more remote computers, such as a remote computing-based device 748. By way of example, the remote computing-based device 748 can be a personal computer, portable computer, a server, a router, a network computer, a peer device or other common network node, and the like. The remote computing-based device 748 is illustrated as a portable computer that can include many or all of the elements and features described herein relative to computer 702.

Logical connections between computer 702 and the remote computer 748 are depicted as a local area network (LAN) 750 and a general wide area network (WAN) 752. Such networking environments are commonplace in offices, enterprise-wide computer networks, intranets, and the Internet.

When implemented in a LAN networking environment, the computer 702 is connected to a local network 750 via a network interface or adapter 754. When implemented in a WAN networking environment, the computer 702 typically includes a modem 756 or other means for establishing communications over the wide network 752. The modem 756, which can be internal or external to computer 702, can be connected to the system bus 708 via the input/output interfaces 740 or other appropriate mechanisms. It is to be appreciated that the illustrated network connections are exemplary and that other means of establishing communication link(s) between the computers 702 and 748 can be employed.

In a networked environment, such as that illustrated with computing environment 700, program modules depicted relative to the computer 702, or portions thereof, may be stored in a remote memory storage device. By way of example, remote application programs 758 reside on a memory device of remote computer 748. For purposes of illustration, application programs and other executable program components such as the operating system are illustrated herein as discrete blocks, although it is recognized that such programs and components reside at various times in different storage components of the computing-based device 702, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Alternately, portions of the framework may be implemented in hardware or a combination of hardware, software, and/or firmware. For example, one or more application specific integrated circuits (ASICs) or programmable logic devices (PLDs) could be designed or programmed to implement one or more portions of the framework.

### CONCLUSION

Although embodiments for implementing the operating system support for web applications have been described in language specific to structural features and/or methods, it is to be understood that the subject of the appended claims is not necessarily limited to the specific features or methods described. Rather, the specific features and methods are disclosed as exemplary implementations for providing the learning technique to generate the ranking model.

What is claimed is:

1. A computing device comprising:
one or more processors;
a first memory one or more processors operatively coupled to the memory;
a caching module in the first memory in the first memory; and
a second memory, wherein the caching module collects web content and stores a copy of the web content as cached web content for later use.

2. The computing device of claim 1, wherein the caching module stores the web from a transport layer of an OS stack directly into the second memory.

3. The computing device of claim 1, wherein the second memory is part of the first memory.

4. The computing device of claim 1, wherein the second memory is an external memory from the computing device.

5. The computing device of claim 1, wherein the second memory includes a user adjustable buffer to store the web content.

6. The computing device of claim 1, wherein the second memory includes a first in first out buffer to store the web content.

7. The computing device of claim 1 further comprising a retrieving module that receives input query from a user to determine if the input query is included in the stored web content.

8. The computing device of claim 7, wherein the retrieving module 116 grays out links and buttons of a web pages that are not stored as web content.

9. A method for caching web content comprising:
receiving a requested web page;
displaying the requested web page;
storing the requested web page as part of caching web content in a memory dedicated for the web content; and
making the web content available for use by user.

10. The method of claim 9, wherein the receiving includes determining whether web content of the requested web page preexists in the memory.

11. The method of claim 9, wherein the receiving includes checking for web content associated with the web page preexisting in the memory.

12. The method of claim 10, wherein the storing is performed directly if the web content of the requested web page does not preexist in the memory.

13. The method of claim 9 further comprising deleting older web content to make room for the web page as part of a first in and first out buffer.

14. The method of claim 9 further comprising overwriting any old versions of the web page with a newer version of the web page.

15. The method of claim 9 further comprising checking the capacity of the memory as the storing is performed.

16. A method for retrieving web content history comprising:
receiving a request for a web page in the web content history, while a user is offline;
determining if the web page is in the web content history in memory; and
displaying the web page if the web page is in the web content history in memory.

17. The method of claim 16 further comprising comparing user queries with queries stored in the memory.

18. The method of claim 16 further comprising fetching predicted possible pages the user may want to visit based on history.

19. The method of claim 16 further comprising determining whether user queries matches queries associated with a web page stored in the memory.

20. The method of claim 16, wherein the method is performed by a web browser.
